(19) United States
(12) Patent Application Publication
(10) Pub. No.: US 2011/0047616 A1
(43) Pub. Date: Feb. 24, 2011

(54) INFORMATION PROCESSING APPARATUS AND ACCESS METHOD

(75) Inventors: Masashi UYAMA, Kawasaki (JP); Naoki SASHIDA, Kawasaki (JP); Kazushi ISHIGAKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/850,965

(22) Filed: Aug. 5, 2010

(30) Foreign Application Priority Data
Aug. 21, 2009 (JP) 2009-191874

(51) Int. Cl. G06F 21/00

(52) U.S. Cl. 726/19

(57) ABSTRACT

An information processing apparatus configured to control authority, the apparatus including a log-in-sequence storage configured to store a log-in ID used to log in the apparatus and a search user ID that is searched for when the apparatus is logged in using the log-in ID in association with each other; a log-in processor configured to accept a log-in ID, and if a search user ID associated with the log-in ID is present in the log-in-sequence storage, to receive the search user ID from an authentication device in the vicinity of the information processing apparatus; and an operation-state reproducer configured to output the screen of an operation state corresponding to the log-in ID received by the log-in processor and the received search user ID with reference to a cooperation-history information table in which log-in IDs and search user IDs are recorded in association with operation states.

### CROSS-REFERENCE TO RELATED APPLICATIONS

This application is based upon and claims the benefit of priority of the prior Japanese Patent Application No. 2009-191874, filed on Aug. 21, 2009, the entire contents of which are incorporated herein by reference.

### FIELD

The present invention relates to an authority control function of an information processing apparatus.

### BACKGROUND

In recent years, as mobile information processing apparatuses, such as notebook computers, (hereinafter referred to as “mobile terminal”) have become multifunctional and compact, they have come into various business uses in companies etc., as well as private uses.

For example, persons who are engaged in sales (hereinafter simply referred to as “salespersons”) take a mobile terminal in which information about a plurality of customers is stored to visit a plurality of customers per day.

During a visit to one customer, unintended display of information about other customers must be avoided from the viewpoint of protecting personal information, maintaining secrecy for business, etc.

Information about a customer being visited may include information that is secret from the customer himself/herself.

Thus, a technology for authenticating all users who are present in the vicinity of a display control unit and displaying only information to which all the users have access right (for example, Japanese Unexamined Patent Application Publication No. 2004-110681).

### SUMMARY

According to an aspect of the invention, an information processing apparatus configured to control authority, the apparatus includes:

a log-in-sequence storage configured to store a log-in ID used to log in the apparatus and a search user ID that is searched for when the apparatus is logged in using the log-in ID in association with each other.

A log-in processor configured to accept a log-in ID, and if a search user ID associated with the log-in ID is present in the log-in-sequence storage, to receive the search user ID from an authentication device in the vicinity of the information processing apparatus.

An operation-state reproducer configured to output the screen of an operation state corresponding to the log-in ID received by the log-in processor and the received search user ID with reference to a cooperation-history information table in which log-in IDs and search user IDs are recorded in association with operation states.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is a diagram illustrating an example of a method for determining the range of data reference and update in a case where a salesperson and a customer cooperate with each other;

FIG. 2 is a diagram illustrating an example of a method for determining the range of applications executable when the salesperson and the customer cooperate;

FIG. 3 is a block diagram illustrating the functional configuration of a mobile terminal and an authentication device;

FIG. 4 is a diagram illustrating an example of the structure and content of a log-in sequence table;

FIG. 5 is a diagram illustrating an example of the structure and content of a data-authority information table;

FIG. 6 is a diagram illustrating an example of the structure and content of an application-execute-authority information table;

FIG. 7 is a diagram illustrating an example of the structure and content of a cooperation-history information table;

FIG. 8 is a diagram illustrating an example of the structure and content of an operation-state-history information table;

FIG. 9 is a flowchart illustrating the authority control process of the mobile terminal; and

FIG. 10 is a flowchart illustrating a process corresponding to an operation.

### DESCRIPTION OF EMBODIMENTS

Reference may now be made in detail to embodiments of the present invention, examples of which are illustrated in the accompanying drawings, wherein like reference numerals refer to like elements throughout.

Data stored in terminal devices, which may be displayed to customers, includes data that customers may freely rewrite and data that users do not want customers to rewrite.

Terminal devices have various applications, some of which users do not want customers to use; for example, a sales-schedule management tool.

If a customer is operating a terminal device with a salesperson, the salesperson can control the terminal device so that, for example, the customer is permitted to use only a specific application. However, if a customer operates the terminal device alone, for example, if the terminal device is lent to the customer, limitation on available applications or the like cannot be given because the salesperson is not present beside the customer. Furthermore, in a case where a customer is permitted to execute an application, some data can be referred to by the customer using the application but some data cannot be updated.

Thus, terminal devices have come to store various items of data and to have various applications. This requires limiting authorities of users on individual items of data and individual applications in accordance with the number of users who use the terminal device, the combination of users, or the like.

Accordingly, it is an object to limit users' authority on data stored in a terminal device depending on the constitution of users who are using the terminal device.

An information processing apparatus according to an aspect of the present invention includes an authority storage that stores a data identifier indicating data, a reference user identifier indicating a user having the authority to refer to the data, and an update user identifier indicating a user having the authority to update the data in association with one another; a detecting section that detects a plurality of user identifiers; a referring section that refers to the data when a reference user identifier stored in association with the data identifier indicating the data includes all the detected user identifiers; and an updating section that updates the data when an update user identifier stored in association with the data identifier indicating the data includes any of the detected user identifiers.

The information processing apparatus can limit users' authority on data stored in the information processing apparatus depending on users who are using the information processing apparatus.

### Embodiment

First, an example of controlling data reference authority, data update authority, application execute authority of a mobile terminal of an embodiment will be described. Hereinafter, controlling those authorities is referred to as “authority control”.

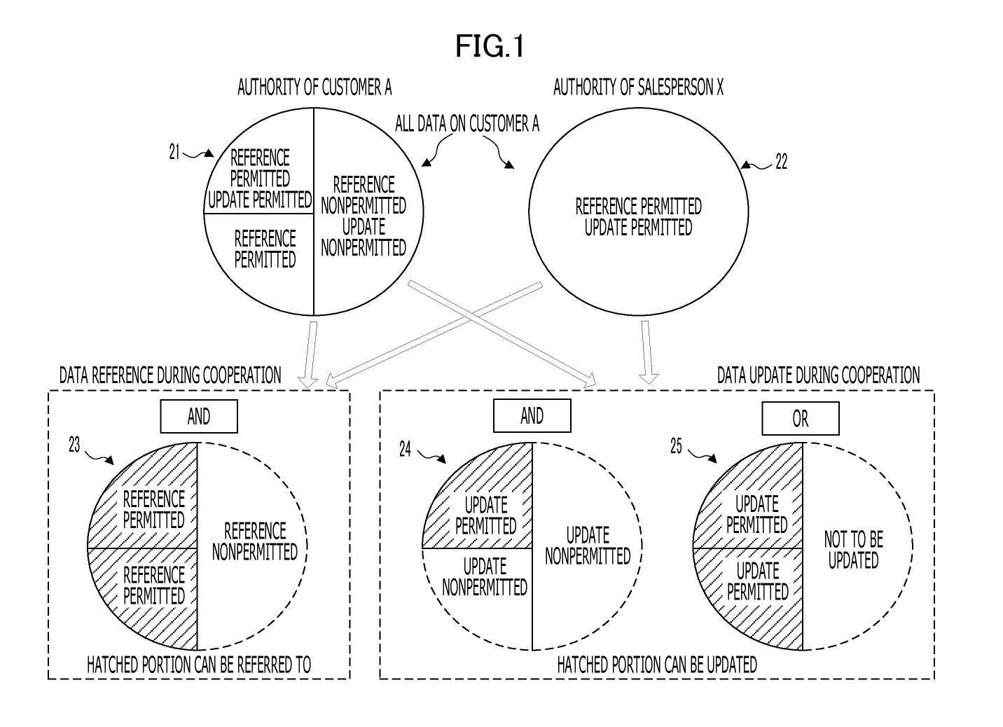

FIG. 1 is a diagram illustrating an example of a method for determining the range of reference and update of data in a case where a salesperson X and a customer A cooperate with each other.

The individual circles in FIG. 1 conceptually illustrate all data about the customer A. Circles 21 and 22 at the upper part of FIG. 1 conceptually illustrate the data by authority in a case where the customer A and the salesperson X individually operate alone using the mobile terminal. The circles at the lower part of FIG. 1 conceptually illustrate the range of data that can be operated when the customer A and the salesperson X operate together, that is, cooperate, using the mobile terminal. The hatched portions indicate operable data.

The salesperson X has reference authority and update authority on all the data about the customer A (see the circle 22 at the upper right in FIG. 1).

On the other hand, the customer A does not have reference authority and update authority on all the data about the customer A himself/herself, even if the data is about the customer A himself/herself. The data about the customer A is divided into three kinds of data, that is, data to which the customer A does not have reference authority, data to which the customer A has reference authority and update authority, and data to which the customer A has reference authority but has not update authority (see the circle 21 at the upper left in FIG. 1).

Here, of the data about the customer A, data that can be operated when the salesperson X and the customer A cooperate will be described. The cooperation on data includes data reference operation and data update operation.

For the data reference operation, data common to data to which the customer A has reference authority and data to which the salesperson X has reference authority, that is, AND data (see a circle 23 at the lower left in FIG. 1), is set as data that can be referred to. The hatched portion in the circle 3 is the data that can be referred to when the customer A and the salesperson X cooperate. Setting the AND data as data that can be referred to eliminates the possibility of showing secret data to the customer A.

Next, for the data update operation, assume that data common to data to which the customer A has update authority and data to which the salesperson X has update authority, that is, AND data, is set as data that can be updated. In this case, data that can be updated is data to which the customer A has update authority (see a circle 24 at the lower center in FIG. 1). The hatched portion in the circle 24 is the data that can be updated when the customer A and the salesperson X cooperate. In other words, in the case where the salesperson X tries to update data to which the salesperson X refers to together with the customer A, data that cannot be updated by the salesperson X is present although the salesperson X has update authority thereto.

Thus, for the data update operation, data to which the customer A has update authority or data to which the salesperson X has update authority, that is, OR data, is set as data that can be updated. Data to which the customer A has not reference authority is not the object to be updated because the data is not referred to and is thus not displayed. In this case, data to be updated is data to which the salesperson X has update authority (see a circle 25 at the lower right in FIG. 1) The hatched portion in the circle 25 is data that can be updated when the customer A and the salesperson X cooperate. In other words, the salesperson X can update data to which the salesperson X refers together with the customer A, even if the customer A has not update authority thereto, provided that the salesperson X has update authority thereto.

In the mobile terminal of the embodiment, for cooperation of a plurality of users, not AND data to which the individual users have authority is operated, but AND and OR are used properly depending on the operation.

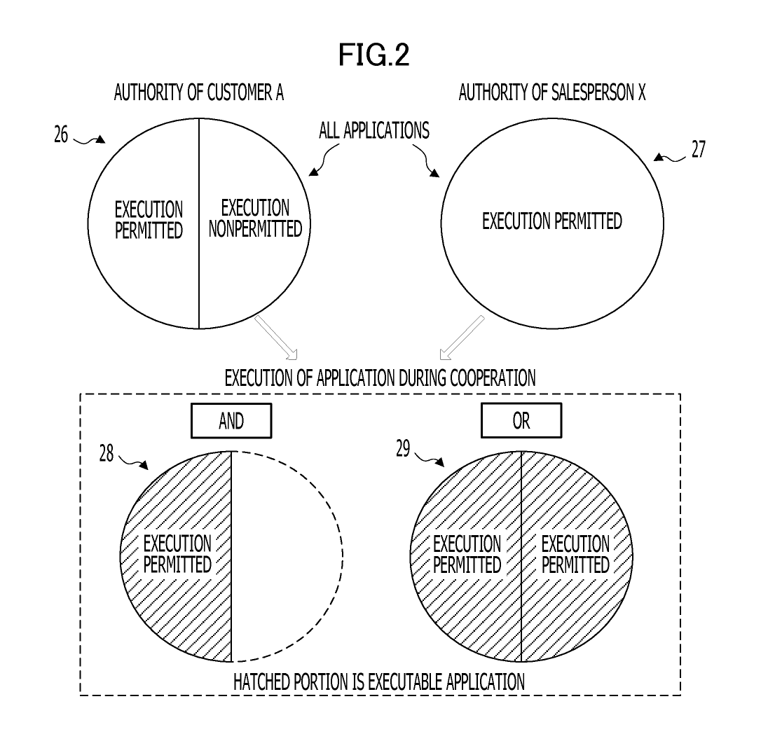

Next, FIG. 2 is a diagram illustrating an example of a method for determining the range of applications executable when the salesperson X and the customer A cooperate.

The circles conceptually illustrate all applications installed in the mobile terminal. Circles 26 and 27 at the upper part of FIG. 2 show applications by authority in a case where the customer A and the salesperson X individually operate alone using the mobile terminal. The circles shown at the lower part of FIG. 2 show applications that can be executed when the customer A and the salesperson X cooperate. The hatched portions indicate the range of executable applications.

The salesperson X has executed authority to all applications installed in the mobile terminal (see a circle 27 at the upper right in FIG. 2).

On the other hand, the customer A has execute authority to part of the applications and has no execute authority for the other applications (see a circle 26 at the upper left in FIG. 2).

Applications that can be executed when the salesperson X and the customer A cooperate will be described hereinbelow.

Applications common to applications to which the customer A has execute authority and applications to which the salesperson X has execute authority, that is, AND applications, are set as applications that can be executed during cooperation.

In this case, the executable applications are applications to which the customer A has execute authority (see a circle 28 at the lower left in FIG. 2). The hatched portion in the circle 28 is the applications that can be executed when the customer A and the salesperson X cooperate.

Only applications to which the customer A has executed authority should be executed during cooperation depending on the kind of application. For example, a browser for presenting a proposed material is an application that can be executed during cooperation with the customer A, but schedule management software etc. of the salesperson X are applications that need not to be executed during cooperation with the customer A.

Accordingly, setting AND applications as executable applications can prevent applications that the salesperson X does not want the customer A to execute from being executed by the customer A.

However, applications that can be executed by the customer A should be applications for referring to only data to which the customer A can refer or applications for updating only data that the customer A can update. This is because, if applications for referring to data to which the customer A has no reference authority are set executable, the customer A can refer to data to which the customer A should not refer. Likewise, applications for updating data to which the customer A has no update authority is set executable, the customer A can update data that the customer A should not update.

However, during cooperation with the customer A, the salesperson X sometimes wants to execute an application for updating data to which only the salesperson X has update authority; for example, an application for performing simulation, to which only the salesperson X has the authority to update a file in which the resultant data is stored.

Thus, for an application executing operation, OR applications are set as executable applications. In this case, the executable applications are applications to which the salesperson X has execute authority (see a circle 29 at the lower right in FIG. 2). In other words, this allows the salesperson X to execute applications, such as an application for updating data that the salesperson X refers to together with the customer A.

In the mobile terminal of the embodiment, for cooperation of a plurality of users, not AND applications to which the individual users have authority are set executable, but AND and OR are used properly depending on the applications.

The applications here may be part of the functions of the applications. For example, since loan simulation software is desirably executed by both the customer A and the salesperson X, both of them have execute authority thereto. This is because the customer A desires to input various items of data serving as the base of the simulation and to see the results.

However, since it is desirable that only the salesperson X is authorized to write the results on a contract, the customer A has not execute authority for reflecting the results to the contract.

Thus, the mobile terminal of the embodiment allows executable operations to be determined in detail depending on an operation that the user wants to do and the authority of the users when the users try to refer to or update stored various items of data and to execute installed various applications. This allows the users to perform desired operations during cooperation and can prevent undesired display or update of data and undesired execution of applications.

The mobile terminal of the embodiment stores information on the state of an executed operation every time the configuration of the users changes, in other words, every time an operation ends. The information on the state of an operation is information on displayed data etc.

When the salesperson X uses the mobile terminal alone thereafter, the mobile terminal can reproduce the state of an operation from the stored information on the state of operations and can perform a subsequent operation; for example, the operation of creating material that cannot be created during the visit to the customer A, such as, assessment of the assets of the customer A. The salesperson X can create such material while viewing a screen on which the state of cooperation with the customer A is reproduced after returning to his/her sales office.

The mobile terminal of the embodiment will be described hereinbelow with reference to the drawings.

Configuration

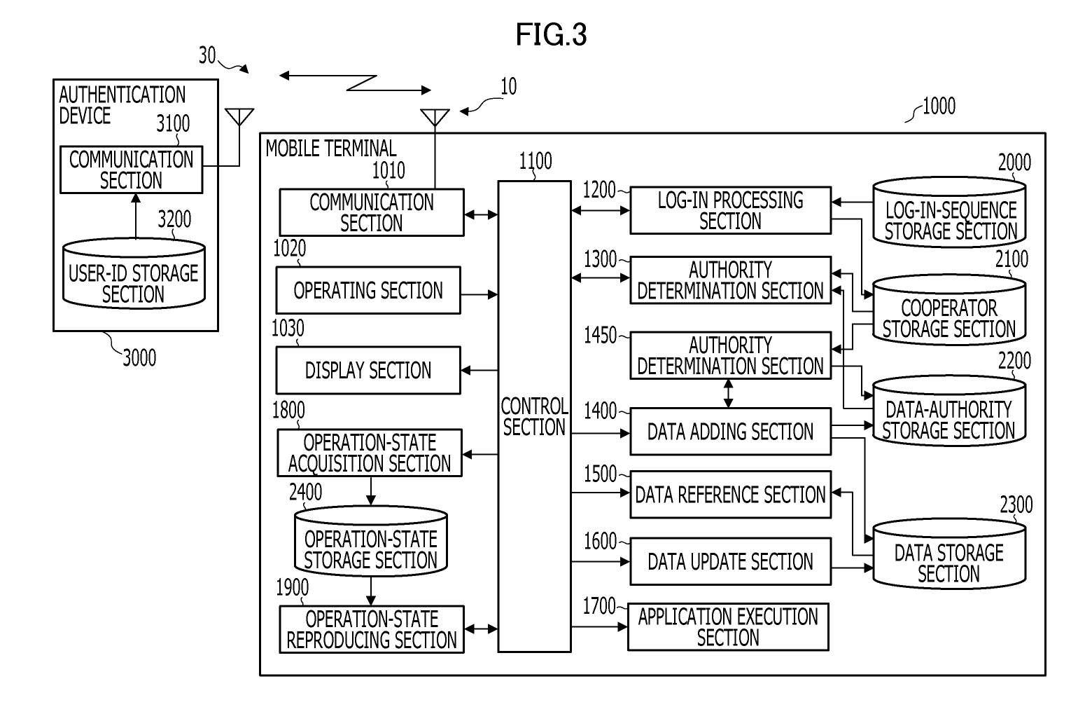

FIG. 3 is a block diagram illustrating the functional configuration of a mobile terminal 1000 and an authentication device 3000.

The mobile terminal 1000 is an information processing apparatus that is carried by the salesperson X who visits the customer A and is used by the salesperson X and the customer A. The authentication device 3000 is carried by the salesperson X, for example, an active type IC (integrated circuit) tag installed in the mobile phone carried by the salesperson X.

The mobile terminal 1000 includes a communication section 1010, an operating section 1020, a display section 1030, a control section 1100, a log-in processor 1200, an authority determiner 1300, a data adding section 1400, an authority determiner 1450, a data reference section 1500, a data update section 1600, an application execution section 1700, an operation-state acquisition section 1800, an operation-state reproducer 1900, a log-in-sequence storage 2000, a cooperator storage 2100, a data-authority storage 2200, a data storage 2300, and an operation-state storage 2400.

The communication section 1010 has the function of communicating with the authentication device 3000 via an antenna 10 by radio.

The operating section 1020 includes keys and has the function of detecting operations from the user, for example, key depression.

The display section 1030 includes a display and has the function of displaying characters etc. on the display. The display section 1030 stores and manages a application for use in display, display data, display positions, display sequence, etc.

The control section 1100 has the fundamental functions of the mobile terminal 1000. In addition to those, the control section 1100 has the function of controlling other functions to achieve the function of authority control.

The log-in processor 1200 has the function of authenticating a user who tries to use the mobile terminal 1000 and storing an affirmatively authenticated user in the cooperator storage 2100. Specifically, the log-in processor 1200 receives a user ID etc. acquired by the communication section 1010 or the operating section 1020 via the control section 1100, determines whether the user has the authority to use the mobile terminal 1000, and stores the user ID authenticated to use the mobile terminal 1000 in the cooperator storage 2100.

The log-in processor 1200 has the function of determining whether to search for a specified user in the surroundings. The log-in processor 1200 refers to the log-in-sequence storage 2000 for the determination. If the log-in processor 1200 has determined to search for a specified user and has authenticated the specified user as the result of search, the log-in processor 1200 stores the user ID of the authenticated specified user in the cooperator storage 2100.

The authority determiner 1300 has the function of determining whether the user has the authority to refer to or update data or the authority to execute an application on the basis of the user ID stored in the cooperator storage 2100.

The data adding section 1400 has the function of adding new data to the data storage 2300.

The authority determiner 1450 has the function of determining the authority of data that the data adding section 1400 adds and storing the authority of the added data in the data-authority storage 2200.

The data reference section 1500 has the function of referring to data stored in the data storage 2300.

The data update section 1600 has the function of updating data stored in the data storage 2300.

The application execution section 1700 includes software for applications and has the function of starting an application in accordance with an instruction from the control section 1100.

The operation-state acquisition section 1800 has the function of acquiring an operation state and storing the operation state in the operation-state storage 2400. The operation state indicates an application in operation, displayed data, or the like. An operation state is acquired every time the cooperator storage 2100 is rewritten, in other words, every time a log-out process is performed.

The operation-state reproducer 1900 has the function of reproducing an operation state from the history of operation states stored in the operation-state storage 2400.

The log-in-sequence storage 2000 has the function of storing the IDs of users who can use the mobile terminal 1000. The log-in-sequence storage 2000 also has the function of storing the ID of a specific user to be searched for if present.

The cooperator storage 2100 has the function of storing the ID of a log-in user. In other words, a plurality of stored user IDs indicates cooperators.

The data storage 2300 has the function of storing data. This data storage 2300 stores data by file.

The data-authority storage 2200 has the function of associating I data stored in the data storage 2300 with the authorities of individual users. Specifically, the data-authority storage 2200 stores file IDs that are the identifiers of files with the authorities of individual users.

The operation-state storage 2400 has the function of storing the history of operation states.

The authentication device 3000 includes a communication section 3100 and a user-ID storage 3200.

The communication section 3100 has the function of communicating with the mobile terminal 1000 by radio. The communication section 3100 has the function of reading user IDs stored in the user-ID storage 3200 upon reception of a request and transmitting the user IDs.

The user-ID storage 3200 has the function of storing a user ID for identifying a user who has the authentication device 3000.

All or part of the functions described above are achieved by the respective CPUs of the mobile terminal 1000 and the authentication device 3000 executing programs stored in the respective memories or the like of the mobile terminal 1000 and the authentication device 3000.

Data

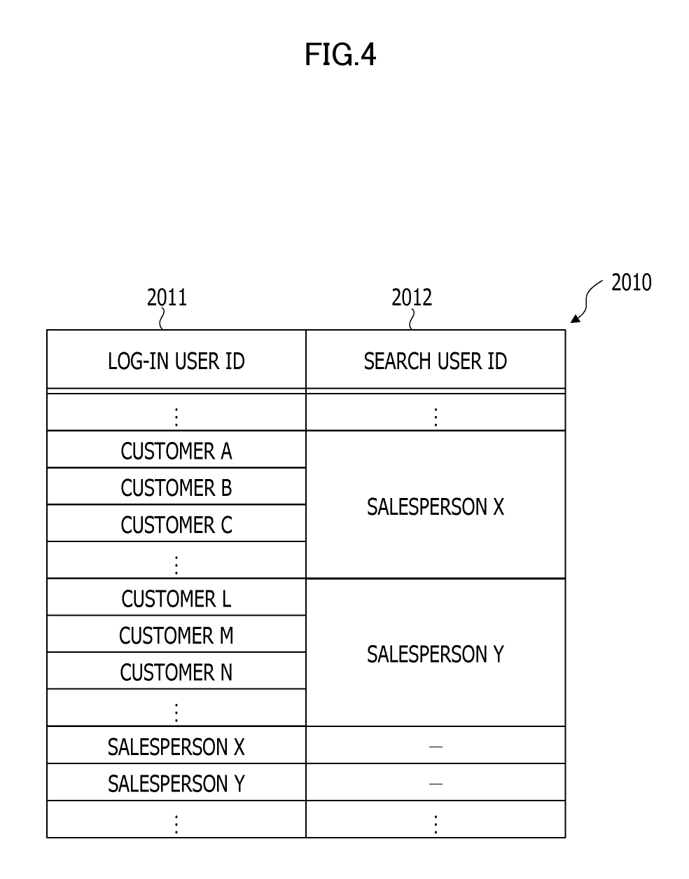

Next, data used in the mobile terminal 1000 will be described with reference to FIGS. 4 to 8.

FIG. 4 is a diagram illustrating an example of the structure and content of a log-in sequence table 2010.

This log-in sequence table 2010 is created and is stored in the log-in-sequence storage 2000 in advance. The log-in sequence table 2010 provides the identifiers of users who can use the mobile terminal 1000 (hereinafter referred to as “user ID”), in which one record is created for each user ID.

The log-in sequence table 2010 provides a log-in user ID 2011 and a search user ID 2012.

The log-in user ID 2011 shows the IDs of users who can use the mobile terminal 1000.

If the same user ID as that input by a user is registered as the log-in user ID 2011 in the log-in sequence table 2010, the mobile terminal 1000 authorizes the user to use the mobile terminal 1000.

The search user ID 2012 shows the ID of a user that the mobile terminal 1000 searches for.

The mobile terminal 1000 searches for a user ID set in the search user ID 2012 in a record in which the log-in user ID 2011 is the same as the user ID of an authorized user.

For example, if a user having a user ID, “customer B”, logs into the mobile terminal 1000, the mobile terminal 1000 searches the surroundings for a user having a user ID, “salesperson X”, because a search user ID 2012, “salesperson X”, corresponds to the log-in user ID 2011, “customer B”.

The user to be searched for is a user who has authority wider than the authority of the log-in user. Specifically, the search user is a user having update authority to data to which the log-in user has no update authority.

If the mobile terminal 1000 has found the search user, it is determined that the log-in user cooperates with a user having wider authority than the log-in user, which increases the authority than when the log-in user operates alone.

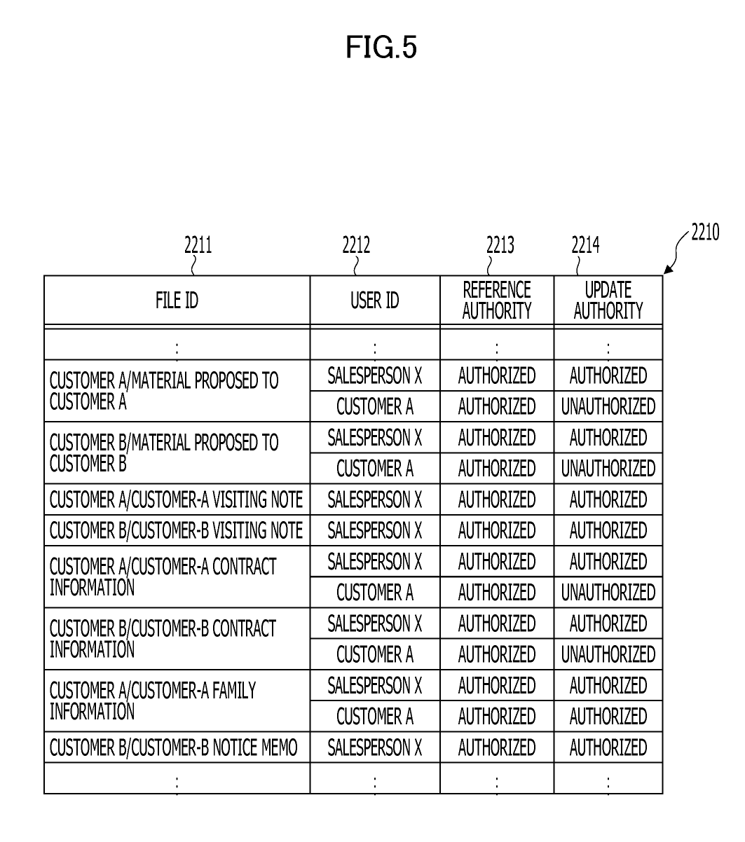

FIG. 5 is a diagram illustrating an example of the structure and content of a data-authority information table 2210.

This data-authority information table 2210 is stored in the data-authority storage 2200. In the data-authority information table 2210, one record is registered for each file, and when one new file is created, one record is added.

The data-authority information table 2210 provides a file ID 2211, a user ID 2212, a reference authority 2213, and an update authority 2214.

The file ID 2211 shows the identifiers of files, specifically, file names.

The user ID 2212 shows the IDs of users related to a file indicated by the file ID 2211. Users having user IDs that are not registered here have no authority to refer to and to update the files shown in the file ID 2211.

The reference authority 2213 shows whether a user indicated by the user ID 2212 has the authority to refer to data indicated by the file ID 2211. “Authorized” shows that the user has reference authority, while “unauthorized” indicates that the user has no reference authority.

The update authority 2214 shows whether a user indicated by the user ID 2212 has the authority to update data indicated by the file ID 2211. “Authorized” shows that the user has update authority, and “unauthorized” shows that the user has no update authority.

For example, for updating data indicated by the file ID 2211, “customer A/material proposed to customer A”, the user indicated by “salesperson X” can update the data because the update authority 2214 of the user ID 2212, “salesperson X”, is “authorized”. In other words, “salesperson X” is a user ID that indicates a user who has the authority to update the data.

Since the update authority 2214 of the user indicated by the user ID 2212, “customer A”, is “unauthorized”, the user indicated by “customer A” cannot update the data. However, since the reference authority 2213 is “authorized”, the user indicated by “customer A” can refer to the data. In other words, “customer A” is a user ID who has the authority to refer to the data.

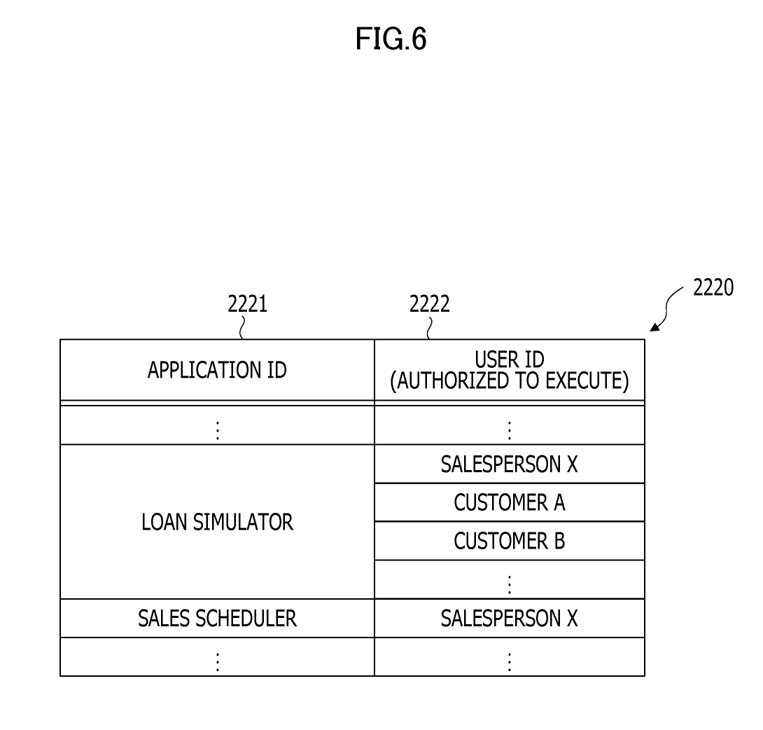

FIG. 6 is a diagram illustrating an example of the structure and content of an application-execute-authority information table 2220.

This application-execute-authority information table 2220 is stored in the data-authority storage 2200. The application-execute-authority information table 2220 has one record for each application.

The application-execute-authority information table 2220 provides an application ID 2221 and a user ID 2222.

The application ID 2221 shows the identifiers of applications. Specifically, the application ID 2221 shows the names of applications.

The user ID 2222 shows the IDs of users who can execute applications indicated by the application ID 2221. Users having user IDs that are not set here have no authority to execute the applications indicated by the application ID 2221.

For example, in executing an application indicated by the application ID 2221, “sales scheduler”, an application indicated by “sales scheduler” can be executed only by a user indicated by “salesperson X” because only “salesperson X” is described in the user ID 2222.

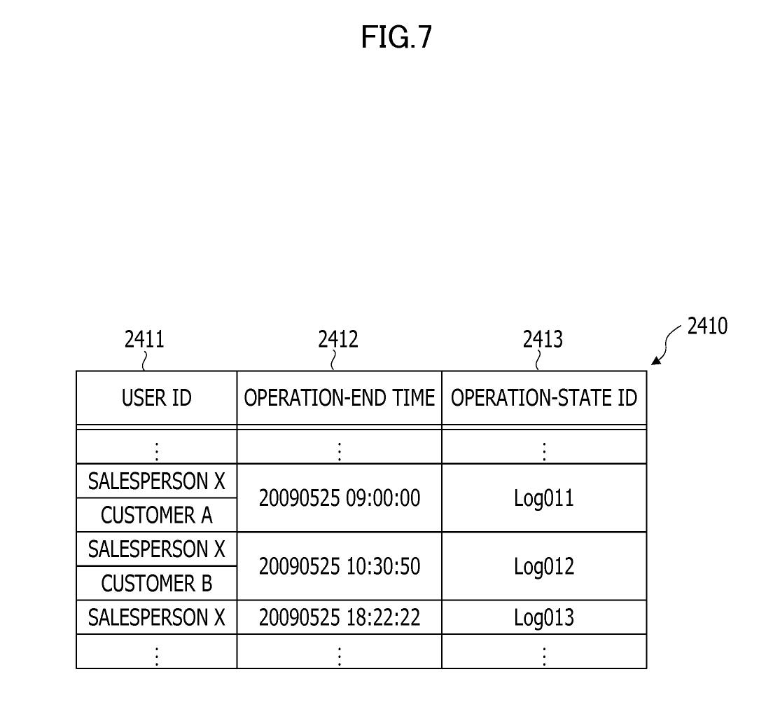

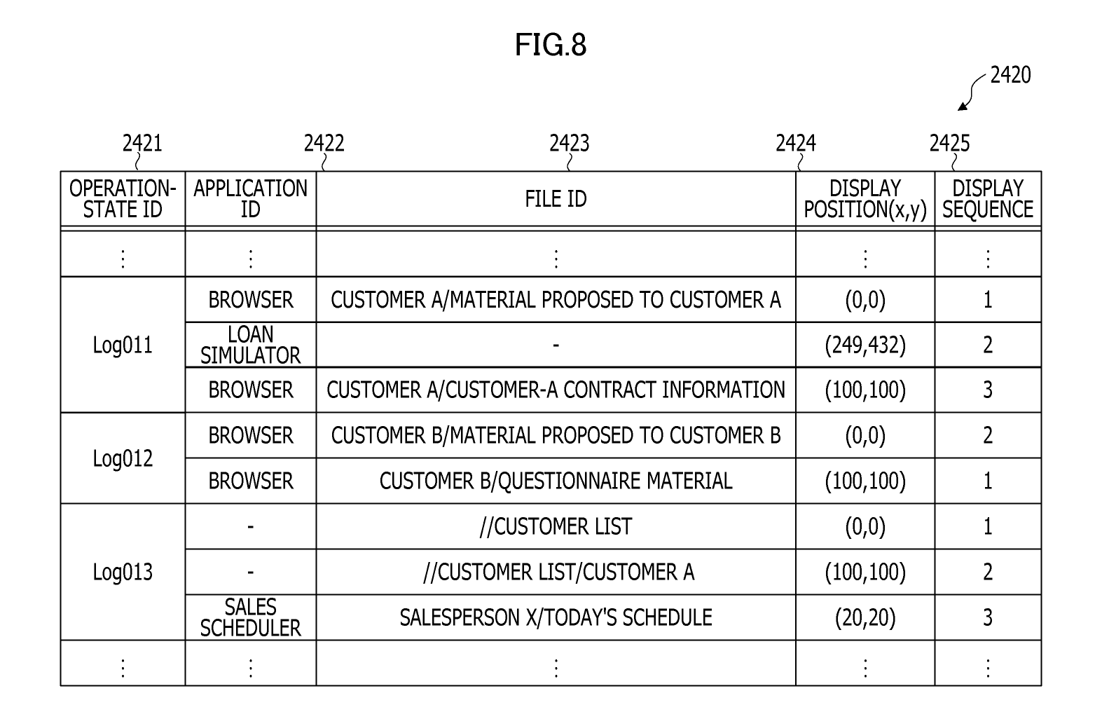

FIG. 7 is a diagram illustrating an example of the structure and content of a cooperation-history information table 2410. FIG. 8 is a diagram illustrating an example of the structure and content of an operation-state-history information table 2420.

The cooperation-history information table 2410 and the operation-state-history information table 2420 are stored in the operation-state storage 2400. The history of operation states is stored using these two tables.

Every time a log-out process occurs, one record is added to each of the cooperation-history information table 2410 and the operation-state-history information table 242.

The cooperation-history information table 2410 provides a user ID 2411, an operation-end time 2412, and an operation-state ID 2413.

The user ID 2411 shows the identifiers of users who have used the mobile terminal 1000, for which user IDs stored in the cooperator storage 2100 are set.

The operation-end time 2412 shows the times when the histories of operation states are acquired.

The operation-state ID 2413 shows the identifiers of the operation states. The details of the operation states are stored in the operation-state-history information table 2420 and are linked thereto using the identifiers of the operation states.

The operation-state-history information table 2420 shows an operation-state ID 2421, an application ID 2422, a file ID 2423, a display position 2424, and a display sequence 2425.

The operation-state ID 2421 shows the identifiers of operation states.

The application ID 2422 shows the identifiers of applications that have been executed in the mobile terminal 1000.

The file ID 2423 shows the identifiers of files used in applications indicated by the application ID 2422.

The display position 2424 shows the positions of applications indicated by the application ID 2422 on the display of a window on which files or the like indicated by the file ID 2423 are displayed.

The display sequence 2425 shows the sequence of windows on which applications indicated by the application ID 2422 display files or the like indicated by the file ID 2423.

Operation

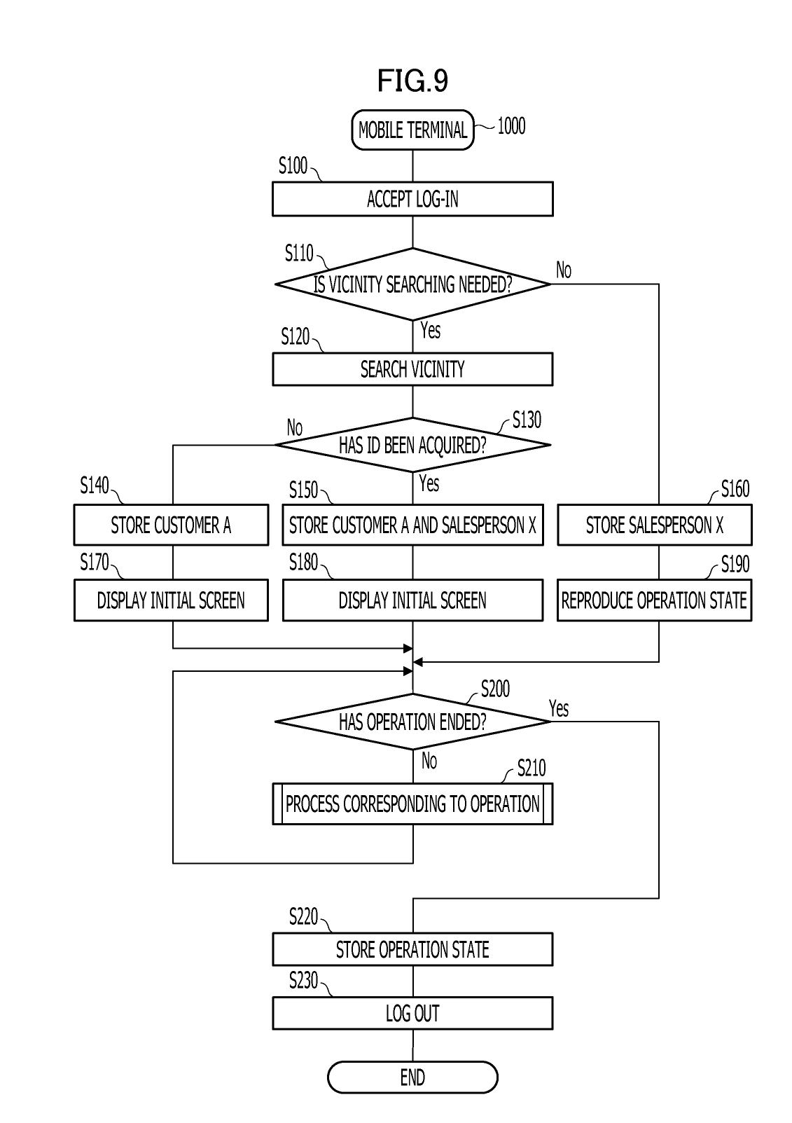

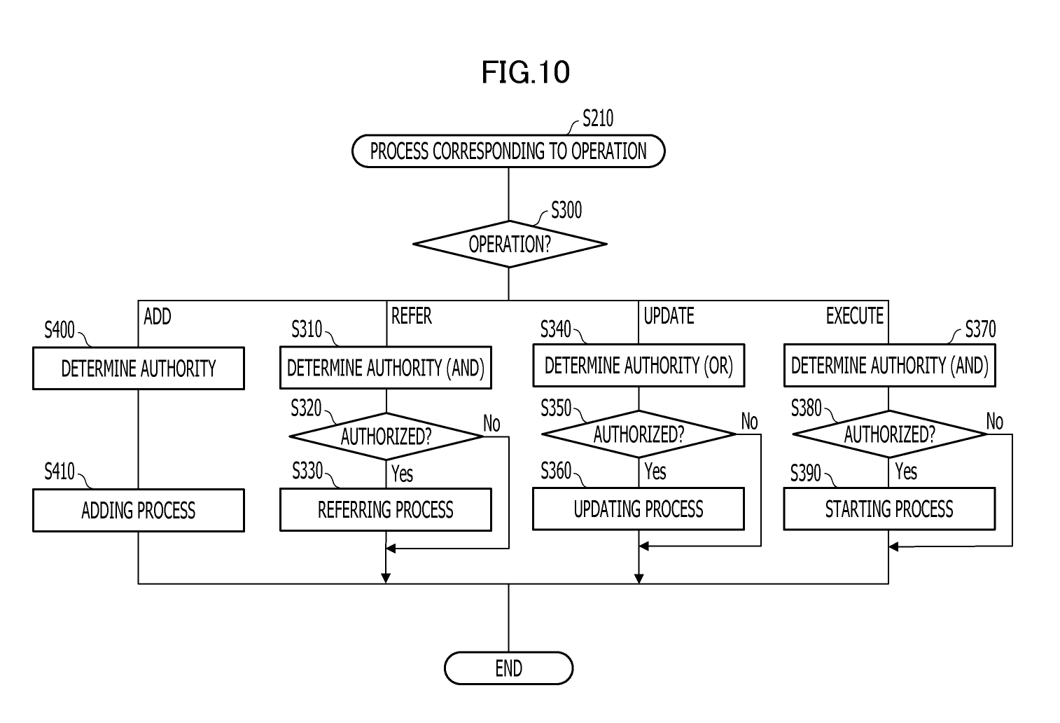

The operation of the mobile terminal 1000 of the embodiment will be described with reference to FIGS. 9 and 10.

FIG. 9 is a flowchart illustrating the authority control process of the mobile terminal 1000.

Operations using the mobile terminal 1000 include a cooperation of the salesperson X and the customer A, such as displaying data about the mobile terminal 1000 together, an independent operation by the customer A, and an independent operation by the salesperson X.

For the cooperation of the salesperson X and the customer A, first, the customer A performs a log-in operation. For example, the customer A enters the user ID of the customer A, “customer A”, with key operation on a log-in screen displayed on the display section 1030. For the independent operation of the customer A or the salesperson X, the customer A or the salesperson X enters his/her user ID with key operation. The salesperson X enters the user ID, “salesperson X”.

The operating section 1020 that has detected the log-in operation extracts the entered user ID (hereinafter referred to as “log-in ID”) and passes the log-in ID to the control section 1100.

The control section 1100 that has received the log-in ID passes the received log-in ID to the log-in processor 1200 and requests a log-in process.

The log-in processor 1200 that has requested to perform the log-in process performs authentication of the passed log-in ID. Specifically, the log-in processor 1200 searches the log-in sequence table 2010 stored in the log-in-sequence storage 2000 for a record in which the same user ID as the log-in ID is set as the log-in user ID 2011.

If the record is found, the log-in processor 1200 determines that the authentication of the log-in ID has succeeded (operation S100).

The log-in processor 1200 that has determined that the authentication has succeeded then determines whether to search the vicinity of the mobile terminal 1000 (operation S110).

Specifically, if some user ID is set as the search user ID 2012 in the record found from the log-in sequence table 2010, the log-in processor 1200 determines that searching is needed, and if no user ID is set, that is, if “-” is set, the log-in processor 1200 determines that searching is not needed.

If the log-in processor 1200 determines that searching is needed (operation S110: Yes), the log-in processor 1200 extracts the set user ID (hereinafter referred to as “search user ID”) and searches the vicinity of the mobile terminal 1000 for the user having the search user ID via the control section 1100 and the communication section 1010 (operation S120). In other words, the log-in processor 1200 tries to acquire the search user ID.

Specifically, the log-in processor 1200 transmits a signal for requesting acknowledgment to the authentication device 3100, such as an IC card, in the vicinity of the mobile terminal 1000 via the communication section 1010.

The communication section 3100 of the authentication device 3000 receives the signal from the mobile terminal 1000 and generates an acknowledge signal. Specifically, the communication section 3100 reads a user ID from the user-ID storage 3200 and generates an acknowledge signal including the read user ID. The communication section 3100 transmits the generated acknowledge signal.

The log-in processor 1200 receives the acknowledge signal responding to the transmitted signal via the communication section 1010. If the received acknowledge signal includes the same user ID as the search user ID, the log-in processor 1200 determines that the user having the search user ID is present in the vicinity. If the log-in processor 1200 has not received an acknowledge signal including the same user ID as the search user ID for a predetermined time, the log-in processor 1200 determines that the user having the search user ID is not present in the vicinity.

If the log-in processor 1200 determines that the user having the search user ID is present in the vicinity of the mobile terminal 1000, the log-in processor 1200 stores the log-in ID passed from the control section 1100 and the search user ID in the cooperator storage 2100 (operation S150).

On the other hand, if the log-in processor 1200 determines that the user having the search user ID is not present in the vicinity of the mobile terminal 1000 and if determines that searching is not needed, the log-in processor 1200 stores only the log-in ID in cooperator storage 2100 (operation S140 or S160).

The log-in processor 1200 that has stored the user ID in the cooperator storage 2100 notifies the control section 1100 that the log-in process has ended and whether vicinity searching has been made.

The control section 1100 that has received the notification that vicinity searching has been made requests the display section 1030 to display an initial screen.

The display section 1030 that has received the request displays the initial screen (operation S170 or S180). The initial screen may be an initial screen for a user indicated by the log-in ID.

On the other hand, if the control section 1100 is notified that no vicinity searching has been made (operation S110: No), the control section 1100 passes the log-in ID and requests the operation-state reproducer 1900 to reproduce the operation state.

The operation-state reproducer 1900 that has received the request reproduces the last operation state of the user having the log-in ID with reference to the cooperation-history information table 2410 and the operation-state-history information table 2420 stored in the operation-state storage 2400 (operation S190).

Specifically, the operation-state reproducer 1900 searches the cooperation-history information table 2410 for a record in which the same user ID as the log-in ID is set as the user ID 2411 in reverse chronological order of the operation-end time 2412.

If the record is found, the operation-state reproducer 1900 reads an identifier set as the operation-state ID 2413 in the record. Next, the operation-state reproducer 1900 searches the operation-state-history information table 2420 for a record in which the same identifier as the read identifier is set as the operation-state ID 2421. The operation-state reproducer 1900 reads the identifier of an application, the identifier of a file, and the position of a window set for the corresponding application ID 2422, file ID 2423, and display position 2424, respectively, in order of increasing number set as the display sequence 2425 in the found record, i.e., in order from 1″ and passes them to the display section 1030 via the control section 1100 and makes a display request.

The display section 1030 that has received the request starts the application indicated by the passed application ID, reads the file indicated by the passed file ID, and displays the content of the read file on the window generated at the passed window position.

After display requests for the largest number set in the display sequence 2425 have been made in sequence, the operation-state reproducer 1900 notifies the control section 1100 of completion of the operation-state reproducing process.

On the other hand, if no record in which in which the same user ID as the log-in ID is set as the user ID 2411 is found in the cooperation-history information table 2410, the display section 1030 displays the initial screen and notifies the control section 1100 of completion of the operation-state reproducing process.

For example, when the salesperson X and the customer A cooperate, first, the user ID, “customer A”, is logged in, and the user having the search user ID, “salesperson X”, is searched for in the vicinity of the mobile terminal 1000. If the user is present in the vicinity, the user ID, “customer A”, and the user ID, “salesperson X”, are stored in the cooperator storage 2100 (operation S150), and the initial screen is displayed (operation S180).

When the customer A operates alone, the user ID, “customer A”, is logged in, and the user having the search user ID, “salesperson X”, is searched for in the vicinity of the mobile terminal 1000 but is not found. Thus, only the user ID, “customer A”, is stored in the cooperator storage 2100 (operation S140), and the initial screen is displayed (operation S170).

When the salesperson X operates alone, the user ID, “salesperson X”, is logged in, and only the user ID, “salesperson X”, is stored in the cooperator storage 2100 because vicinity searching is not needed (operation S160). Then, the last operation state of the salesperson X is reproduced (operation S190).

The control section 1100 that has displayed the initial screen or has reproduced the operation state waits for the next user operation to be detected.

The operating section 1020 that has detected the user operation passes the detected operation to the control section 1100.

If the user operation is not an instruction to terminate the operation (operation S200: No), then the control section 1100 that has received the user operation performs a process corresponding to the operation (operation S210). This process will be described later with reference to FIG. 10.

If the received user operation is an instruction to terminate the operation (operation S200: Yes), the control section 1100 requests the operation-state acquisition section 1800 to acquire the operation state and store it.

The operation-state acquisition section 1800 that has received the request acquires the information of the displayed screen from the display section 1030 via the control section 1100 and stores the information in the operation-state storage 2400 (operation S220).

Specifically, the operation-state acquisition section 1800 inquires of the display section 1030 about the position of the present window, the identifier of data displayed on the window, and the identifier of an application for displaying the data.

The display section 1030 that has received the inquiry passes the position of the present window, the identifier of data displayed on the window, and the identifier of the application for displaying the data to the operation-state acquisition section 1800. At that time, if a plurality of windows are generated, the display section 1030 returns the windows in increasing order of the windows numbered from “1”.

The operation-state acquisition section 1800 that has received the position of the present window, the identifier of data displayed on the window, the identifier of the application for displaying the data, and the number of the order creates records to be added to the cooperation-history information table 2410 and the operation-state-history information table 2420.

First, the operation-state acquisition section 1800 creates a record to be added to the cooperation-history information table 2410.

Specifically, the operation-state acquisition section 1800 reads a user ID stored in the cooperator storage 2100 and sets the user ID as the user ID 2411. The operation-state acquisition section 1800 acquires, as the operation-end time 2412, time from a timer in the mobile terminal 1000 and sets the time. The operation-state acquisition section 1800 sets a unique identifier as the operation-state ID 2413.

The operation-state acquisition section 1800 that has created the record adds the record to the cooperation-history information table 2410.

Next, the operation-state acquisition section 1800 creates a record to be added to the operation-state-history information table 2420.

Specifically, the operation-state reproducer 1900 sets, as the operation-state ID 2421, the identifier set as the operation-state ID 2413 of the record added to the cooperation-history information table 2410. The operation-state reproducer 1900 further sets the position of the window, the identifier of data displayed on the window, the identifier of the application for displaying the data, and the number of the order received from the display section 1030 as the application ID 2422, the file ID 2423, the display position 2424, and the display sequence 2425, respectively.

The operation-state acquisition section 1800 that has created the record adds the record to the operation-state-history information table 2420.

The operation-state acquisition section 1800 that has added the records notifies the control section 1100 that the operation state has been stored.

The control section 1100 that has received the notification that the operation state has been stored deletes the user ID stored in the cooperator storage 2100 and thereafter performs a log-out process (operation S230).

Next, a process corresponding to an operation will be described using FIG. 10.

FIG. 10 is a flowchart illustrating a process corresponding to an operation.

If the operation is an instruction to refer to data (operation S300: Refer), the control section 1100 passes the identifier of the data to be referred to (hereinafter referred to as “reference-data identifier”) to the authority determiner 1300 and makes a request for determination of authority.

The authority determiner 1300 that has received the request for determination determines whether the user who is using the mobile terminal 1000 at present has the authority to refer to the data indicated by the received reference-data identifier (operation S310).

Specifically, first, the authority determiner 1300 reads a user ID stored in the cooperator storage 2100. If a plurality of user IDs are stored, the authority determiner 1300 reads all of the user IDs.

Next, the authority determiner 1300 searches the data-authority information table 2210 stored in the data-authority storage 2200 for a record in which the same identifier as the received reference-data identifier is set as the file ID 2211.

The authority determiner 1300 determines whether the same user ID as the user ID read from the cooperator storage 2100 is set as the user ID 2212 in the found record. If there are a plurality of user IDs read from the cooperator storage 2100, the authority determiner 1300 determines whether the individual user IDs have been set as the user ID 2212. If any one of the user IDs has not been set, the authority determiner 1300 determines that the user is “unauthorized”.

If all of the user IDs have been set, the authority determiner 1300 reads the reference authority 2213 corresponding to the individual user IDs to determine whether all of the users are “authorized”. If all of the user IDs are “authorized”, the authority determiner 1300 determines that the user is “authorized”, and if any one of the user IDs is “unauthorized”, the authority determiner 1300 determines that the user is “unauthorized”.

The authority determiner 1300 that has determined whether the user has the authority to refer to the data indicated by the reference-data identifier received from the control section 1100 returns the result of determination, that is, “authorized” or “unauthorized”, to the control section 1100.

If the received determination result is “unauthorized” (operation S320: No), the control section 1100 terminates the process.

If the received determination result is “authorized” (operation S320: Yes), the control section 1100 passes the reference-data identifier to the data reference section 1500 and makes a request to refer to the data.

The data reference section 1500 that has received the request reads the data indicated by the received reference-data identifier from the data storage 2300 and passes the read data to the display section 1030 via the control section 1100 and makes a request to display the data. The display section 1030 that has received the request displays the passed data about the display (operation S330). The data reference section 1500 may pass the read data not to the display section 1030 but to an application, for example.

On the other hand, if the user operation that the control section 1100 has received is an instruction to update data (operation S300: Update), the control section 1100 passes the identifier of data to be updated (hereinafter referred to as “update-data identifier”) to the authority determiner 1300 and makes a request to determine the authority.

The authority determiner 1300 that has received the request for determination determines whether the user who is using the mobile terminal 1000 at present has the authority to update the data indicated by the received reference-data identifier (operation S340).

Specifically, first, the authority determiner 1300 reads a user ID stored in the cooperator storage 2100. If a plurality of user IDs are stored, the authority determiner 1300 reads all of the user IDs.

Next, the authority determiner 1300 searches the data-authority information table 2210 stored in the data-authority storage 2200 for a record in which the same identifier as the received reference-data identifier is set as the file ID 2211.

The authority determiner 1300 determines whether the same user ID as the user ID read from the cooperator storage 2100 is set as the user ID 2212 in the found record. If there are a plurality of user IDs read from the cooperator storage 2100, the authority determiner 1300 determines whether any of the user IDs has been set as the user ID 2212. If any one of the user IDs has not been set, the authority determiner 1300 determines that the user is “unauthorized”.

If any of the user IDs has been set, the authority determiner 1300 reads the update authority 2214 corresponding to the user ID, and if the use ID is “authorized”, the authority determiner 1300 determines that the user is “authorized”, and if the user ID is “unauthorized”, the authority determiner 1300 determines that the user is “unauthorized”. At that time, if the reference authority 2213 corresponding to the user ID is “unauthorized”, the authority determiner 1300 determines that the user is “unauthorized” irrespective of what the update authority 2214 indicates.

The authority determiner 1300 that has determined whether the user has the authority to update the data indicated by the update-data identifier received from the control section 1100 returns the result of determination, that is, “authorized” or “unauthorized”, to the control section 1100.

If the received determination result is “unauthorized” (operation S340: No), the control section 1100 terminates the process.

If the received determination result is “authorized” (operation S350: Yes), the control section 1100 passes the update-data identifier to the data update section 1600 and makes a request to update the data.

The data update section 1600 that has received the request updates the data indicated by the received update-data identifier and stored in the data storage 2300 in response to the request form the control section 1100 (operation S360). For example, if new data is passed from the control section 1100, the data update section 1600 rewrites the stored data to the new data.

If the user operation that the control section 1100 has received is an instruction to start an application (operation S300: Execute), the control section 1100 passes the identifier of the application to be executed (hereinafter referred to as “application identifier”) to the authority determiner 1300 and makes a request for determination of authority.

The authority determiner 1300 that has received the request for determination determines whether the user who is using the mobile terminal 1000 at present has the authority to execute the application indicated by the received application identifier (operation S370).

Specifically, first, the authority determiner 1300 reads a user ID stored in the cooperator storage 2100. If a plurality of user IDs are stored, the authority determiner 1300 reads all of the user IDs.

Next, the authority determiner 1300 searches the application-execute-authority information table 2220 stored in the data-authority storage 2200 for a record in which the same identifier as the received application identifier is set as the application ID 2221.

The authority determiner 1300 determines whether the same user ID as the user ID read from the cooperator storage 2100 is set as the user ID 2212 in the found record. If there are a plurality of user IDs read from the cooperator storage 2100, the authority determiner 1300 determines whether any of the user IDs has been set as the user ID 2212. If any one of the user IDs is not set, the authority determiner 1300 determines that the user is “unauthorized”.

If any of the user IDs has been set, the authority determiner 1300 determines that the user is “authorized”.

The authority determiner 1300 that has determined whether the user has the authority to execute the application indicated by the application identifier received from the control section 1100 returns the result of determination, that is, “authorized” or “unauthorized”, to the control section 1100.

If the received determination result is “unauthorized” (operation S380: No), the control section 1100 terminates the process.

If the received determination result is “authorized” (operation S380: Yes), the control section 1100 that has received the determination result passes the application identifier to the application execution section 1700 and makes a request to execute the application.

The application execution section 1700 that has received the request starts the application indicated by the received application identifier (operation S390).

If the user operation that the control section 1100 has received is an instruction to add data, that is, to add a file (operation S300: Add), the control section 1100 passes the identifier of the file to be added, specifically, a file name (hereinafter referred to as “file identifier”), to the data adding section 1400 and makes a request to add the data.

The data adding section 1400 that has received the request for adding the data requests the authority determiner 1450 to determine the authority and to register the authority information of the data to be added in the data-authority information table 2210.

The authority determiner 1450 that has received the request for determination determines a user having the authority to refer to the file indicated by the received file identifier and a user having the authority to update the file on the basis of the user who is using the mobile terminal 1000 at present (operation S400).

Next, the authority determiner 1450 creates a record to be added to the application-execute-authority information table 2210 stored in the data-authority storage 2200.

Specifically, the authority determiner 1450 sets a file identifier as the file ID 2211. Next, the control section 1100 reads user IDs stored in the cooperator storage 2100 and sets the user IDs as the user ID 2212. The control section 1100 then sets “authorized” as the reference authority 2213 and the update authority 2214 corresponding to the individual user IDs set as the user ID 2212.

The authority determiner 1450 that has created the records adds the created records to the data-authority information table 2210.

The authority determiner 1450 that has added the records notifies the data adding section 1400 of the addition.

The data adding section 1400 that has received the notification stores the file indicated by the file identifier in the data storage 2300 (operation S410).

Supplement

Although an embodiment of the present invention has been described above, the present invention is not limited thereto but may have the following configuration:

(1) Although the embodiment is configured such that, for reproduction of an operation state, the newest operation state is reproduced, the reproduction may be made after one of the operation states is selected by the user. For example, assume that the salesperson X comes back to the sales office after visiting the customer A and next a customer B. The salesperson X can make a memo by reproducing, not the newest operation state, but the state of operation with the customer A.

(2) Although the embodiment is configured, in the log-in process, to try to acquire a search user ID from an IC card carried by the salesperson X and to transmit a signal to the vicinity of the mobile terminal 1000, the search user ID may be acquired by another method. An example is displaying a log-in screen on the display of the mobile terminal 1000 to prompt the user to enter the user ID and the password of the salesperson X.

(3) The mobile terminal 1000 may achieve part or all of the components in FIG. 3 etc. using a one-chip or a multi-chip integrated circuit.

(4) The mobile terminal 1000 may achieve part or all of the components in FIG. 3 etc. using a computer program or any other forms.

The computer program may be written to any recording medium, such as a memory card or a CD-ROM, and may be executed by a computer that reads it. The program may be downloaded to a mobile terminal via a network and may be executed by the mobile terminal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An information processing apparatus configured to control authority, the apparatus comprising:
a log-in-sequence storage configured to store a log-in ID used to log in the apparatus and a search user ID that is searched for when the apparatus is logged in using the log-in ID in association with each other;
a log-in processor configured to accept a log-in ID, and if a search user ID associated with the log-in ID is present in the log-in-sequence storage, to receive the search user ID from an authentication device in the vicinity of the information processing apparatus;
an operation-state reproducer configured to output the screen of an operation state corresponding to the log-in ID received by the log-in processor and the received search user ID with reference to a cooperation-history information table in which log-in IDs and search user IDs are recorded in association with operation states.

2. The information processing apparatus according to claim 1, wherein
the cooperation-history information table includes an operation-state ID that specifies an operation state; and
the operation-state reproducer starts an application corresponding to an operation-state ID corresponding to the log-in ID received by the log-in processor and the received search user ID and output the application with reference to an operation-state-history information table in which operation-state IDs and operated applications are associated with each other.

3. The information processing apparatus according to claim 1, wherein
the operation-state-history information table includes files in association with operations; and
the operation-state reproducer outputs an operated file using an application corresponding to the operation-state ID to a screen.

4. An information processing apparatus configured to control authority, the apparatus comprising:
a log-in-sequence storage configured to store a log-in ID used to log in the apparatus and a search user ID that is searched for when the apparatus is logged in using the log-in ID in association with each other;
a log-in processor configured to accept a log-in ID, and if a search user ID associated with the log-in ID is present in the log-in-sequence storage, to receive the search user ID from an authentication device;
an authority determiner configured, upon reception of the identifier of operated data, to determine the authority of the log-in ID received by the log-in processor and the received search user ID with reference to a data-authority storage that stores a data identifier indicating data, a reference user identifier indicating a user having the authority to refer to the data, and an update user identifier indicating a user having the authority to update the data in association with one another.

5. A method for controlling authority for an information processing apparatus, the method comprising the operations of:
receiving a log-in ID;
if a search user ID associated with the log-in ID is present in a log-in-sequence storage that stores a log-in ID used to log in the apparatus and a search user ID that is searched for when the apparatus is logged in using the log-in ID in association with each other, receiving the search user ID from an authentication device in the vicinity of the information processing apparatus; and
outputting the screen of an operation state corresponding to the log-in ID received by the log-in processor and the received search user ID with reference to a cooperation-history information table in which log-in IDs and search user IDs are recorded in association with operation states.
